(19) United States
(12) Patent Application Publication
(10) Pub. No.: US 2005/0060920 A1
(43) Pub. Date: Mar. 24, 2005

(54) Rotational filing system for compact disks

(76) Inventor: Michael Sharon, Givataym (IL)

Correspondence Address: PATRICK J. GLYNN;SUITE 129, 5818 EAST UNIVERSITY BLVD., DALLAS, TX, 75206, US

(21) Appl. No.: 10/755,161

(22) Filed: Jan. 12, 2004

Related U.S. Application Data
(60) Provisional application No. 60/504,689, filed on Sep. 22, 2003.

(51) Int. Cl. G09F 23/10

(52) U.S. Cl. 40/360; 40/641

(57) ABSTRACT

A rotational filing system is described for storing and retrieving compact disks. According to one embodiment, a carrier is combined with an associated compact disk forming a unit included in a plurality of such units that are adjacent and rotate about a common axis on a support means. The carrier is a flat shaped body, the preferred carrier being disk-shaped equivalent in size to its associated compact disk, and includes a means for attachment to its associated compact disk that coincides with the circular hole provided in the center of the compact disk and has a tab containing indicia in reference to the associated compact disk, said tab extending beyond the periphery of said associated compact disk. In the case where the units are stacked instead of positioned upright, a second tab is provided for lifting a particular unit from the stack. Another embodiment includes an improvement wherein compact disks are stacked upon a spindle extending upright through the center hole of each disk wherein the carrier body underlying its associated compact disk has a circular hole that coincides with the compact disk hole, in place of the means for attachment, forming discrete units that rotate about the spindle. In another embodiment, the carrier is a disk-shaped pouch sized to contain its associated compact disk. In yet another embodiment, the preferred disk shaped carrier is applied as a compact disk file divider in the upright position without attachment means.

This application claims the benefit of U.S. Provisional Application No 60,504,689 filed Sep. 22, 2003.

### BACKGROUND OF THE INVENTION

The present invention relates to the storage and retrieval of compact disks. Compact disks are popular for storing electronic information, such as, data, computer software, audio and visual material and especially music. Convenience dictates that such disks are stored at or near a work-station, such as, a computer or CD Player. Therefore a desk top filing and retrieval system that capitalizes on the economy of size of the compact disk and utilizes its circular form is advantageous.

Indexing tabs for compact disks that are currently available do not include a flat surface that serves a protector of the content surface of the compact disk and a carrier for the storage and retrieval of compact disks outside their original commercial container.

### SUMMARY OF THE INVENTION

The present invention relates to a desk top rotational filing system for compact disks by incorporating compact disks into a system of storage and retrieval outside their original commercial containers. According to the invention, a carrier is combined with an associated compact disk having a circular hole in its center to form a discrete carrier-compact disk unit. Each unit is positioned adjacent to other such units to from a uniform plurality of discrete carrier-compact disk units that are positioned on a support means so they can rotate about a common axis. The carrier comprises a flat shaped body including a zone that coincides with the center hole of its associated compact disk and has at least one tab containing indicia in reference to the digital material stored on the compact disk and extends beyond the periphery of the associated compact disk.

According to one aspect of the invention, the carrier body includes a means for removable attachment that coincides with the center hole of the associated compact disk. The means for removable attachment is adapted to engage the edge of the compact disk defining its center hole.

The carrier body is flat with opposite surfaces and can take any shape that is included within the area of the associated compact disk; however, if the carrier body extends beyond the periphery of the associated compact disk, it must be disk-shaped in order to rotate effectively on a support means. Preferably, the carrier has a body that is disk shaped and equivalent in size to the associated compact disk and can be a disk-shaped carrier pouch that is sized to contain its associated compact disk.

According to the embodiments of the invention each discrete carrier-compact disk unit is positioned substantially upright forming a uniform plurality of such units on a support means adapted so the units can rotate about a common axis or stacked to form a uniform column of such units that rotate about a common vertical axis. When stacked, each unit includes two tabs that are positioned opposite to each other so they can be simultaneously grasped to lift a desired the unit from the stack.

The rotational filing system of the invention operates so that once the plurality of discrete units are formed, the tabs are moved from side to side by rotating the units about a common axis until the desired indicia containing tab is found. The unit containing that tab is then removed from the plurality of units comprising the compact disk file. The compact disk thereby selected is separated from its carrier for immediate use or temporarily placed as a unit on a working surface apart from the rotational filing system. In this way, the content surface of the compact disk is protected by its carrier surface. A preferred support means comprises a housing adapted so that the adjacent units in the rotational filing system are aligned to rotate about a common axis.

Another aspect of the invention is an improvement in the case where compact disks are stored by stacking them upon a spindle extending vertically through the hole in each disk, the improvement incorporating a carrier underlying its associated compact disk and adapted to the spindle by a hole that is congruent to the hole in the compact disk.

Another aspect of the invention, is a disk-shaped compact disk file divider without attachment means and having an indicia tab in reference to an adjacent compact disk stored in a substantially upright position in a rotational file storage and retrieval system.

### BRIEF DESCRIPTION OF THE DRAWINGS

FIG. 1 is a perspective view of a preferred embodiment of the rotational filing system of the present invention resting in a housing and employing the carrier pouch of the present invention.

FIG. 2 is a front elevation view of a preferred embodiment of the carrier body with flanging means for attachment.

FIG. 3 is a front elevation view of the carrier body with an alternate flanging means for attachment.

FIG. 4 is a close-up of the flanging means of FIG. 2.

FIG. 5 is a close-up of an alternate flanging means of FIG. 3.

FIG. 6 is a perspective view of a preferred carrier body with associated compact disk before being combined.

FIG. 7 is a perspective view of a preferred carrier-compact disk unit with flanging means for attachment.

FIG. 8 is a front elevation view an alternate carrier body forming a carrier-compact disk unit with including flanging means for attachment.

FIG. 9 is a front elevation view of an alternate carrier body with opposite tabs and including a hole that matches the center hole of a compact disk.

FIG. 10 is a front elevation view of the carrier pouch.

FIG. 11 is a perspective view of the preferred carrier pouch of FIG. 10 containing an associated compact disk.

FIG. 12 is a front elevation view of a preferred carrier body having a hollow hub.

FIG. 13 is a vertical sectional view taken substantially upon a plane passing along line 54-54 of FIG. 12.

FIG. 14 is a horizontal sectional view of two carrier-compact disk units that are stacked to form a uniform column, wherein each carrier has a hollow hub at the center and includes opposite tabs.

FIG. 15 is a perspective view of an improved plurality of compact disks stacked about a spindle acting as a support means employing the carrier pouch.

FIG. 16 is a front elevation view of a preferred disk shaped carrier body including opposite tabs and a hole that is congruent with center hole of the compact disk.

FIG. 17 is a perspective view of a plurality of preferred carrier-compact disk units illustrating removal or replacement of one such unit according to the method of the present invention.

FIG. 18 is a horizontal sectional view of a preferred carrier-compact disk unit disposed in a housing as the support means FIG. 19 is a horizontal sectional view of an alternate carrier-compact disk unit disposed in a housing as the support means.

### DETAILED DESCRIPTION OF THE PREFERRED EMBODIMENT OF THE INVENTION

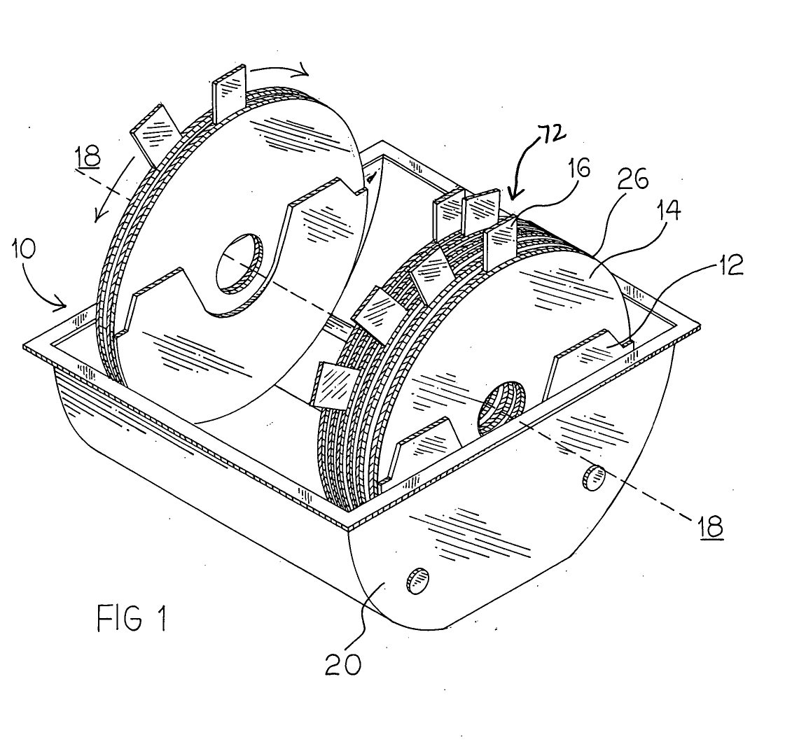

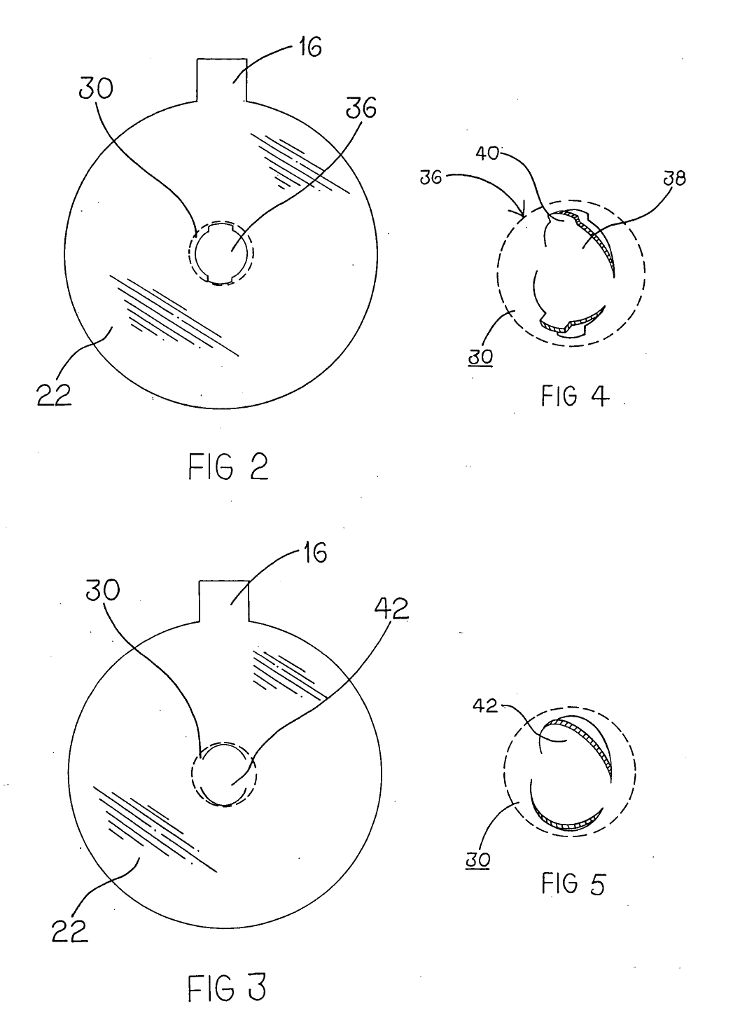

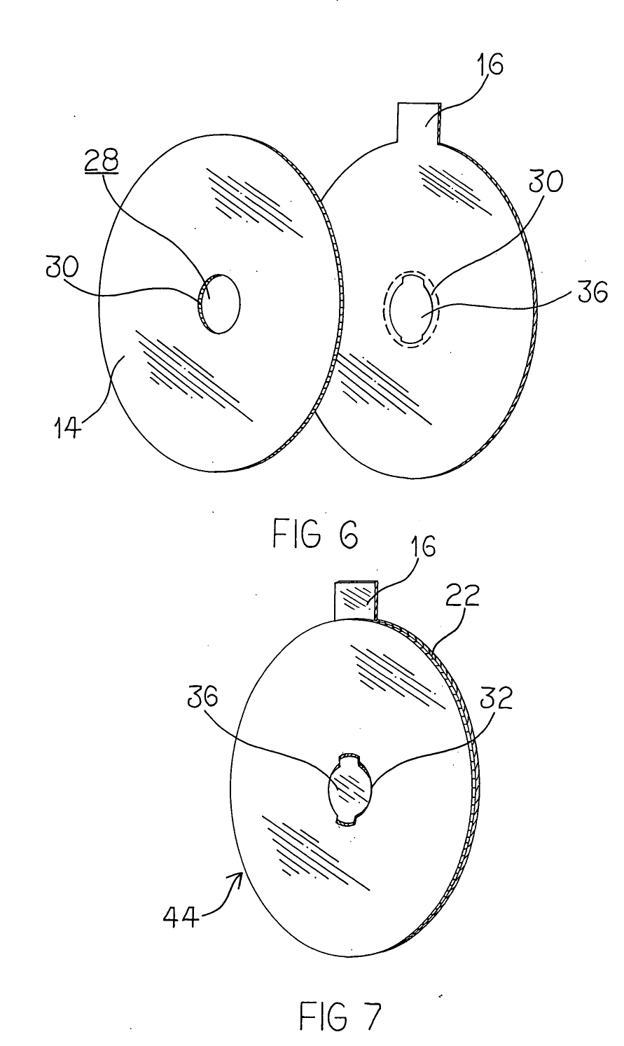

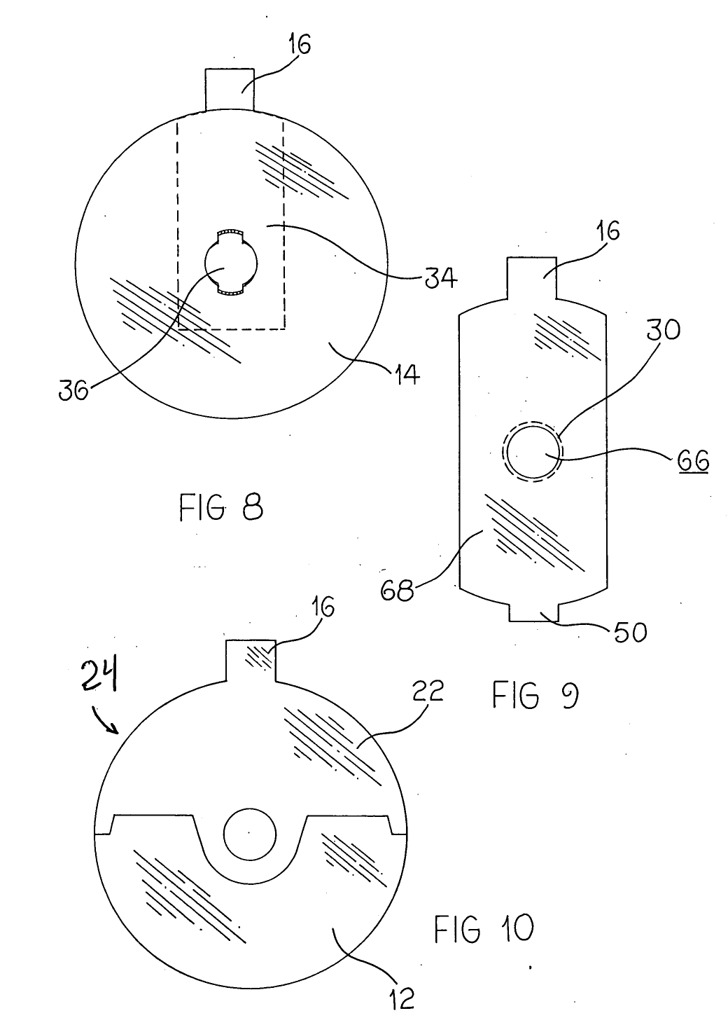

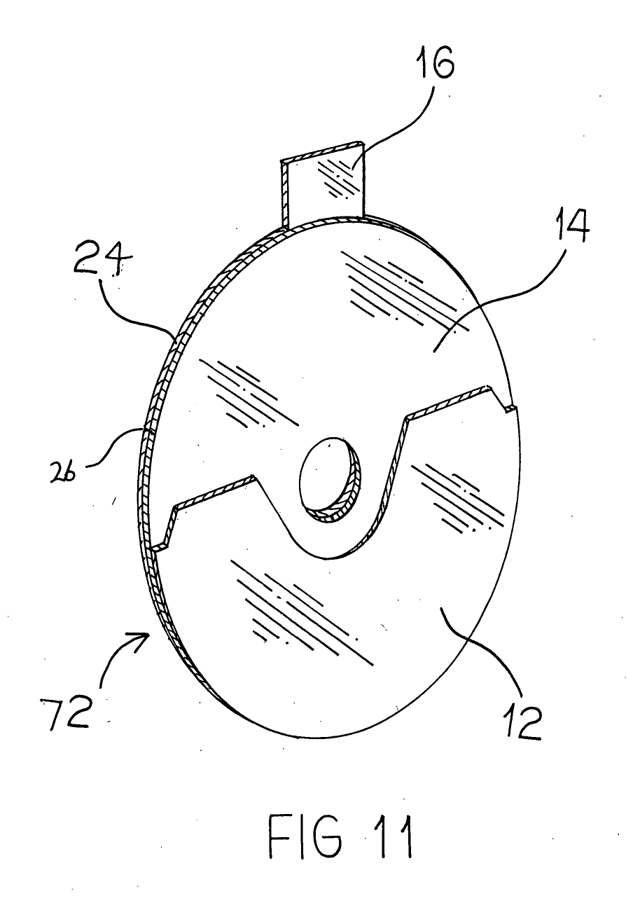

FIG. 1 illustrates an alternate embodiment of the rotational filing system 10 of the invention. Each compact disk 14 is contained in a semi-circular sleeve 12 with indicia tab 16 extending from the disk shaped carrier body 22 shown in FIG. 10. This forms the carrier pouch 24 with the sleeve 12 shown in FIG. 10. FIG. 11 shows the pouch 24 containing compact disk 14 forming the carrier pouch unit 72. FIG. 1 therefore shows a uniform plurality of units 72 comprising the pouch 24 including compact disk 14 that rotate about the common horizontal axis 18. As shown in FIGS. 1 and 11, the indicia tab 16 extends beyond periphery 26 of the compact disk 14. The indicia tab 16 can include numerical indicia, alphabetic indicia or other recognizable and distinguishable indicia including but not limited to surface ornamentation, color distinction, geometrical configurations and the like that identifies the electronic or digital data stored on compact disk 14. As shown in FIG. 6, the preferred carrier body 22 includes a zone 30 which coincides with the circular hole 28 of the compact disk 14 when the compact disk 14 and carrier body 22 are combined to form the preferred carrier-compact disk unit 44 in FIG. 7, including attachment means 36. According to the invention, the means for attaching the carrier body to its associated compact disk resides at zone 30 which coincides with compact disk hole 28. Referring to FIG. 4, a preferred means for attachment is shown by enlarged area of the zone 30 of the preferred disk-shaped carrier body 22 in FIG. 2, wherein a flange 36 is provided including a semicircular segment 38 with extension 40 that extends though the hole 28 of the compact disk 14 in order to engage the edge 32 defining hole 28. In reference again to FIG. 7, the carrier body 22 is shown combined with the compact disk 14 by attachment means 36. The flange 36 extends through the hole 28, shown in FIG. 6, and has engaged the edge 32 defining hole 28 in order to form the preferred carrier-compact disk unit 44. FIG. 5 is an enlarged area of zone 30 in FIG. 3 and shows an alternate attachment means 42 including two semi-circular components. Although the preferred carrier body is disk shaped, seized to the dimensions of the associated compact disk, an alternate form of carrier body 34 is shown in FIG. 8 employing the attachment means 36. Therefore, the carrier body can be any shape so long as it is included within the surface area of the compact disk 14 as shown in FIG. 8.

FIG. 18 shows the preferred carrier-compact disk unit 44 disposed in housing 20 as viewed in horizontal cross-section. Raised sections 46, contained in the housing, are provided as a support means for minimal frictional engagement of the unit 44 so that the unit 44 can rotate freely within the housing 20. As shown by the arrows in FIG. 18, unit 44 can rotate right or left. When are a plurality of such units are disposed in housing 20, for example, each unit rotates right or left about the common axis 18 until the desired indicia tab is located. The unit 44 including the desired indicia tab 16 is then removed from the housing and, after use placed back into the housing 20 as shown by the arrows in FIG. 17. Referring to FIG. 19, an alternate carrier body 34 is shown with its associated compact disk 14. As noted above, the flat carrier body can be any shape so long as it is included within the surface area of compact disk 14. In the configuration shown FIG. 19 only the circular edge 26 of compact disk 14 makes rotational contact with raised areas 46 in housing 20 while, on the other hand, the entire carrier-compact disk unit 44 in FIG. 18 makes rotational contact with raised areas 46.

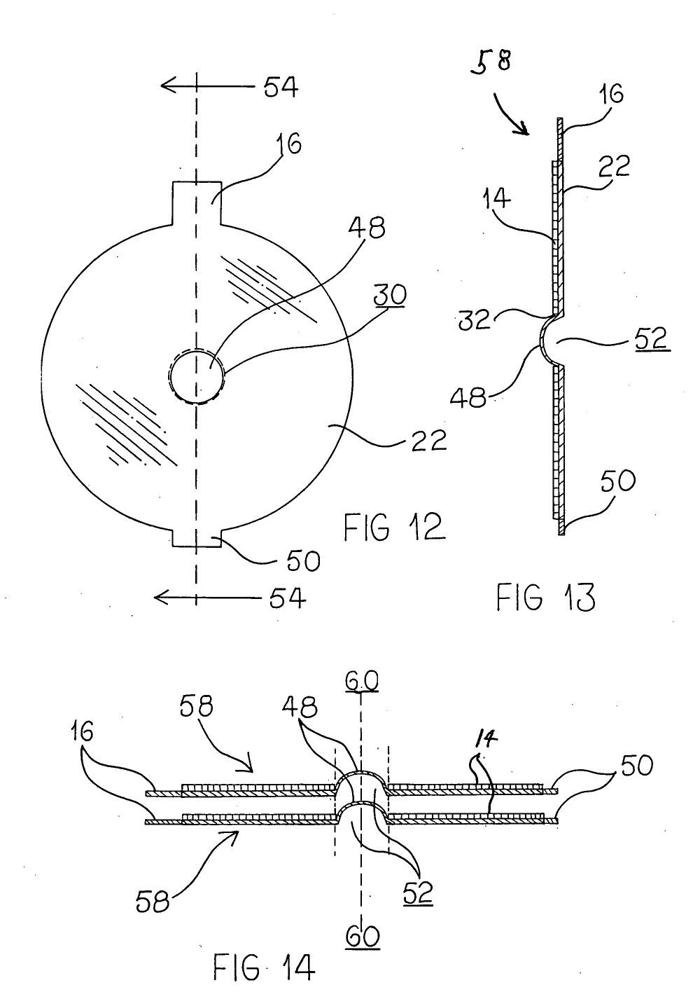

In the embodiments of the rotational filing system shown in FIGS. 1, 17, 18 and 19, the carrier-compact disk units are positioned substantially upright; however, alternatively the rotational filing system includes carrier-compact disk units that are stacked to form a uniform column of units. Accordingly, the carrier disk body 22 includes a second tab 50 extending from carrier body 22 opposite indicia tab 16 shown in FIG. 12, so that both tabs can be simultaneously grasped to lift a carrier compact-disk unit from the stack of discrete carrier-compact disk units. This configuration requires, therefore, that each carrier body 22 underlies its associated compact disk 14. A hub 48 projecting above the surface of carrier body 22 in the zone 30 is provided as the means for attachment for engaging the edge 32 defining hole 28 of compact disk 14 to form the carrier-compact disk unit 58 shown in the vertical sectional view of FIG. 13 taken substantially upon a plane passing along line 54-54 of FIG. 12. As shown in FIG. 13, the hub 48 is preferably dome-shaped projecting above the surface of carrier body 22 in zone 30 forming a depression 52 at the opposite surface of carrier body 22 that is the inversion of preferred dome-shaped hub 48, thus forming a convex-concave element. In referring to the horizontal sectional view of FIG. 14, the hub 48 engages the depression 52 of the overlying unit 58 forming a plurality of units that are stacked upon one another to form a uniform column of discrete units 58 that rotate about the common vertical axis 60. The hub of each unit 58 thereby serves as a support means for each overlying unit 58 forming a uniform column of stacked units that rotate clock-wise or counter-clockwise about the vertical axis 60.

Although the dome-like hub 48 is preferred, the present invention includes a hub of any shape that can be mounted over the like hub of an adjacent carrier-compact disk unit that is adapted for the free rotation of the carrier-compact disk units about the vertical axis 60 when they are stacked, such as, a means for attachment that has one or more cylindrical elements or is conical. However, when the carrier-compact disk units are positioned upright on a support means, such as, shown in FIGS. 1, 17, 18 and 19 the present invention includes any suitable means for attachment of the carrier body to its associated compact disk, including, but not limited to dome-shaped, conical, cylindrical, square, rectangular, triangular or tapered configurations that project from the surface of one side of the flat shaped carrier body and engage a portion or all of the edge defining the central circular hole 28 of the compact disk 14, although flange 36 and flange 42 are preferred. Furthermore, the means for attachment can be formed by a projection from the surface on one side of the carrier body or be a separate element that is attached to the carrier body using a suitable adhesive material.

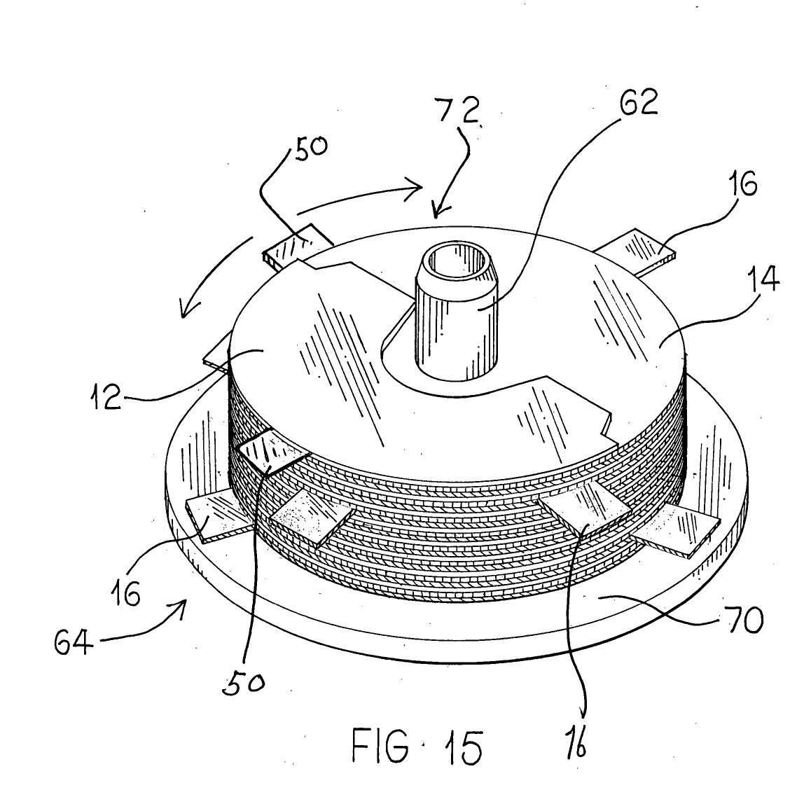

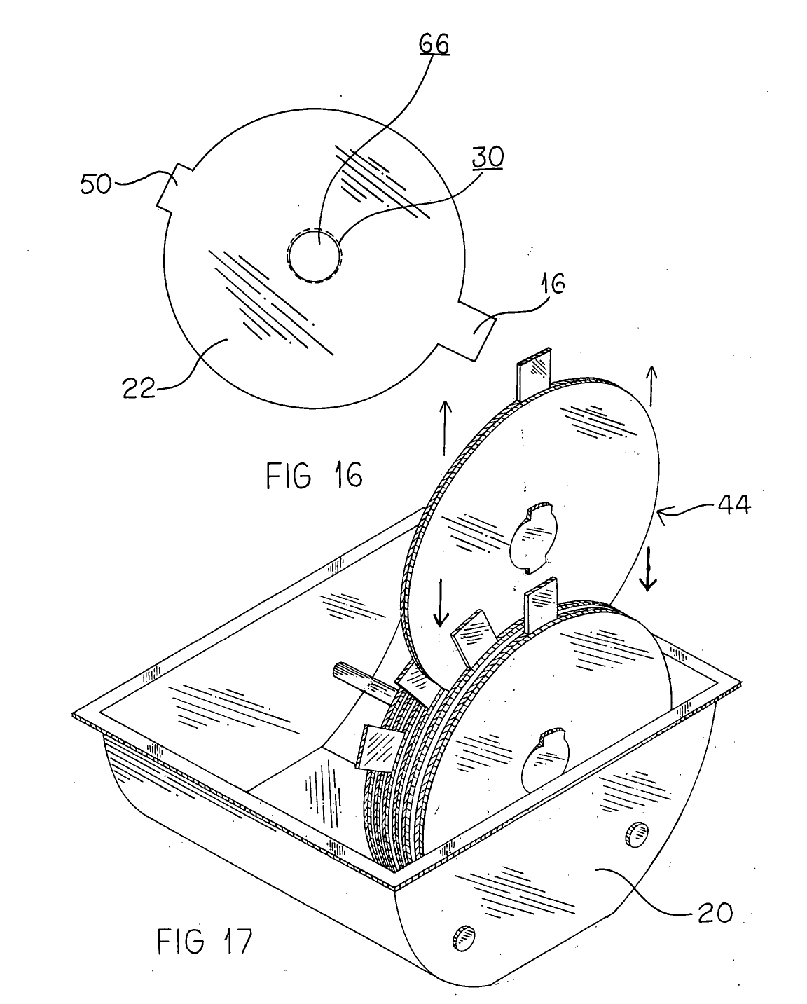

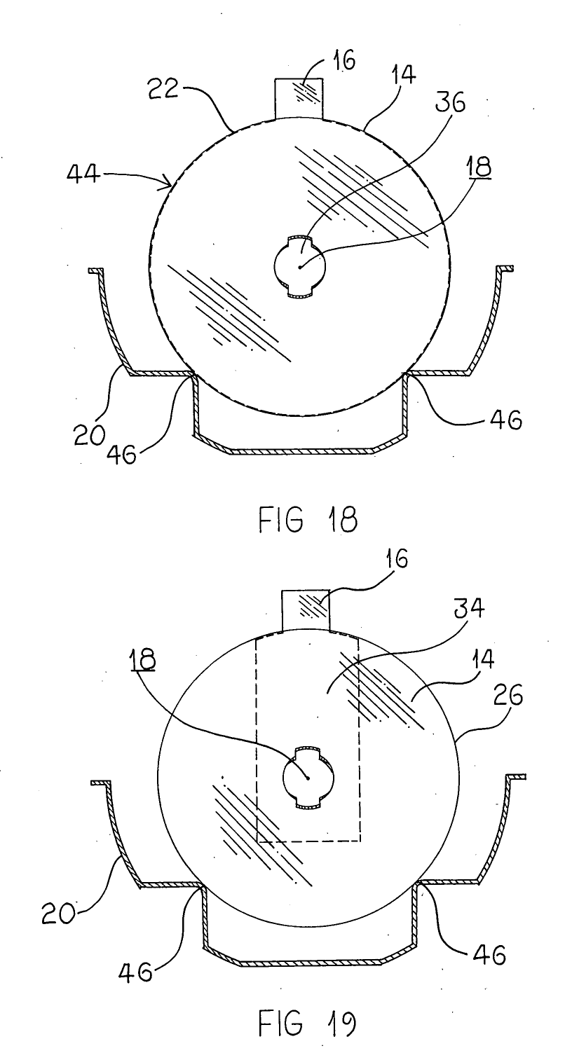

The present invention also includes an improvement wherein a plurality of compact disks 14 are stacked upon a spindle having a base as a support means. Ordinarily, when stacked upon a spindle the fact that the compact disks can rotate about the spindle has no significance; however, the improvement utilizes this rotational characteristic of such configuration. Accordingly, the preferred disk-shaped carrier body 22 is adapted to be included in such a plurality of compact disks. FIG. 16 shows the preferred carrier body 22 including indicia tab 16 and opposite tab 50 and including hole 66 that lies in zone 30. As pointed out above in reference to the preferred disk shaped body, carrier zone 30 coincides with compact disk hole 28 when the carrier body is combined with its associated compact disk 14 by attachment means in zone 30. In this improvement for compact disks, stacked upon a spindle, hole 66 replaces the attachment means in zone 30 of the carrier body, so that the carrier and its associated compact disk are combined without attachment means. Hole 66 is sized and aligned with compact disk hole 28 so that both holes are congruent forming a carrier-compact disk unit that rotates about the spindle. FIG. 9 shows an alternate carrier body 68 including hole 66 that is sized to fit the spindle. Each carrier body includes the indicia tab 16 and the opposite tab 50 for lifting the underlying carrier and its associated compact disk from the spindle. FIG. 15 shows a stack of carrier pouch units 72, including the semi-circular sleeve 12, stacked about spindle 62 resting on support means 70 forming the stacked column of carrier pouch units 64 that rotate clock-wise or counter-clockwise as shown by the arrows.

In selecting a compact disk stored according to the filing system of the present invention the carrier-compact disk units are rotated manually by moving indicia tabs 16 to the right or left or clockwise or counter-clockwise (when stacked) until the desired indicia tab is found, removing the unit containing the desired indicia tab (for example in FIG. 17) and separating the carrier from its associated compact disk for use. In addition to storage and retrieval, the carrier body serves to protect the content surface of the compact disk outside of its original commercial container when stored according to the present invention, or when a particular carrier-compact disk unit is removed from the rotational file and placed upon a working surface without separating the carrier from its associated compact disk in anticipation of use. The carrier and support means can made of any light-weight material such durable plastic, cardboard or light weight metallic materials.

The present invention also includes a rotational filing system including the preferred disk-shaped body 22 and indicia tab 16 as a compact disk file divider in the upright position without attachment means, wherein the disk-shaped body 22 is adjacent or contiguous to its associated compact disk.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof

1. A rotational filing system for storing and retrieving a compact disk having a circular hole in the center, comprising: a carrier for combining with a compact disk, wherein said carrier is included in a plurality of said carriers that are adjacent to one another and rotate about a common axis on a support means, said carrier having a flat shaped body and opposite sides and a means for removable attachment to said associated compact disk that coincides with said associated compact disk center hole, said carrier body having at least one tab containing indicia in reference to said associated compact disk and extending beyond the periphery of said associated compact disk.

2. The rotational filing system of claim 1 wherein said carrier body is disk-shaped.

3. The rotational filing system of claim 2 wherein said means for removable attachment is a flange projecting from one side of said carrier body for engaging the periphery defined by said compact disk center hole.

4. The rotational filing system of claim 2 wherein said means for removable attachment is a hollow hub projecting from one side of said carrier body for engaging the periphery defined by said compact disk center hole, said hub having a depression at the opposite side of said carrier body for receiving a like hub of an identical carrier so that each said carrier is removably coupled forming a plurality of discrete rotational carriers that are stacked to form a column wherein they rotate about a common vertical axis.

5. The rotational filing system of claim 4 wherein said carrier body further includes a second tab that is positioned opposite to said indicia containing tab and extends beyond the periphery of said compact disk.

6. The rotational filing system of claim 1 wherein said support means is a housing that includes said plurality of carriers that are positioned substantially upright, said housing being adapted for the free rotation of said carriers about said common axis.

7. An improved system for storing and retrieving compact disks, wherein a plurality of compact disks are stacked upon a spindle forming a column so that said plurality of compact disks can freely rotate about said spindle that extends upright through a circular hole provided in the center of each compact disk, the improvement comprising: a carrier associated with each compact included in said plurality, said carrier having a flat shaped body and a circular hole that is congruent with said compact disk circular hole and having a first tab containing indicia in reference to the compact disk to which said carrier is associated and a second tab positioned opposite to said indicia containing tab, both tabs extending beyond the periphery of the compact disk to which said carrier is associated so that both tabs can be grasped simultaneously for the removal of a desired compact disk and its associated carrier from said column.

8. The improved system of claim 7 wherein said carrier body is disk-shaped.

9. The improved system of claim 8 wherein said disk-shaped body has a sleeve forming a carrier pouch that is sized to include the compact disk to which said carrier pouch is associated.

10. A compact disk file divider, comprising: a disk-shaped body in association with an adjacent compact disk, said body being at least equivalent in size to said compact disk and having at least one tab containing indicia in reference to said compact disk extending beyond the periphery of said compact disk.

11. A rotational filing system for storing and retrieving a compact disk, comprising: a disk-shaped pouch that is sized for the containment of an associated compact disk, wherein said pouch is included in a plurality of said pouches that are adjacent to one another and rotate about a common axis on a support means, said disk-shaped pouch having at least one tab containing indicia in reference to said associated compact disk and extending beyond the periphery of said associated compact disk.

12. The rotational filing system of claim 11 wherein said support means is a housing that includes said plurality of pouches that are positioned substantially upright, said housing being adapted for the free rotation of said pouches about said common axis.
